(19) United States
(12) Patent Application Publication
(10) Pub. No.: US 2021/0351713 A1
(43) Pub. Date: Nov. 11, 2021

(54) MULTILEVEL RESONANT DC-DC CONVERTER

(71) Applicant: KONINKLIJKE PHILIPS N.V., EINDHOVEN (NL)

(72) Inventors: ALBERT GARCIA I TORMO, EINDHOVEN (NL); BERNHARD WAGNER, HAMBURG (DE); PETER LURKENS, AACHEN (DE)

(21) Appl. No.: 16/322,506

(22) PCT Filed: Jul. 31, 2017
(86) PCT No.: PCT/EP2017/069278

§ 371 Date: Feb. 1, 2019

(30) Foreign Application Priority Data
Aug. 1, 2016 (EP) 16182162.4

(51) Int. Cl. H02M 3/335; H02M 1/00; H05G 1/12

(52) U.S. Cl. CPC H02M 3/33592; H05G 1/12; H02M 1/007; H02M 1/0058

(57) ABSTRACT

Resonant DC-DC converters use a switching network to step a single DC voltage up to a working DC level using a resonant tank. However, high voltage DC power supply systems, for example, those used to power X-ray sources, are increasingly being integrated into smaller form factors, and it is becoming attractive to be able to make use of multiple DC-DC power supplies to power such X-ray sources. The present invention provides a topology for a resonant DC-DC converter, a DC electrical supply system, and method of operating a DC-DC resonant converter. The proposed topology uses a switching network to connect multiple DC power supplies to the resonant tank, to enable a more flexible provision of input power.

### FIELD OF THE INVENTION

This invention relates generally to the field of resonant DC-DC converters, DC electrical supply systems comprising resonant DC-DC converters, and methods for operating resonant DC-DC converters.

### BACKGROUND OF THE INVENTION

High-Voltage generators, as used for example in X-ray applications, generally use a resonant converter topology, because of the high-voltage and high-power requirements of such applications. A general resonant converter topology is illustrated in FIG. 1. A DC power supply 10 provides a DC voltage across input terminals of the generic resonant converter 12. A first stage 14 having power switches controls the voltage provided from the supply 10. A resonant tank 16 and a transformer 18 provide voltage gain and Galvanic isolation. A rectifier 20 is provided which may also provide voltage gain. Thus, a converted DC voltage can be supplied to load 22.

Although the resonant converter topology is an effective and efficient power supply topology in X-ray applications, demands to further miniaturize hardware and improve supply efficiency and flexibility means that such topologies may be further improved.

US 2014/0146572 discusses a power converter employing a class of the resonant converter topology discussed above.

T.-F. Wu and J.-C. Hung, A PDM Controlled Series Resonant Multi-level Converter Applied for X-ray Generators”, Power Electronics Specialists Conference, 1999. PESC 99. 30th Annual IEEE Charleston, S.C., USA 27 Jun.-1 Jul. 1999, Pascataway, N.J., USA IEEE, US, Vol. 2, 27 Jun. 1999, pages 1177-1182, is a paper that presents analysis, design and practical consideration of a pulse density modulation controlled series resonant multilevel converter applied for x-ray generators. The proposed converter is operated at 100 kHz and with a maximum output power of 30 kW. The resonant tank of the converter is operated slightly above its resonance to achieve zero voltage switching and low turnoff loss at switching transition, resulting in low loss. With the multilevel configuration, the voltage imposed on the switches is only half of the input voltage.

DE102005036806A1 describes that a common series circuit of the secondary sides of the transformers is provided for parallel resonance converters, which can be connected or connected to a load circuit via a respective transformer. Thus, despite the scattering of the frequency-determining components, it can be achieved that, with synchronous clocking of the bridge circuits of the resonance converter, all resonance converters feed an output-side load circuit with approximately the same power. CN102201754B describes topology and constant-frequency voltage hysteresis control of a multi-level inverter which has constant switching frequency and is based on a serial resonant soft switch. The multi-level inverter comprises a unidirectional multi-level inverter and a bidirectional multi-level inverter; a switch device is arranged on one side of the unidirectional multilevel inverter; a complementary conducting way is adopted in different resonant current directions in the same state; switch devices are arranged on both sides of the bidirectional multilevel inverter and are easy to control; the voltage hysteresis control comprises direct voltage hysteresis control and indirect voltages hysteresis control; in the direct voltage hysteresis control, output voltage is taken as a comparison object; and in the indirect hysteresis control, the output of a regulator is taken as a comparison object. Due to the adoption of the voltage hysteresis control based on the multi-level inverter, rapid and stable control over the output voltage can be realized; and the voltage hysteresis control can applied to a high-frequency DC/DC (Direct Current-Direct Current) converter.

### SUMMARY OF THE INVENTION

According to a first aspect, there is provided a resonant DC-DC converter.

The resonant DC-DC converter comprises:
a resonant tank having first and second input nodes;
a switching network configured to select a first external voltage supply from a first set of external voltage supplies and configured to select a second external voltage supply from a second set of external voltage supplies and to connect the selected first and second external voltage supplies to respective first and second input nodes of the resonant tank.

The resonant DC-DC converter also comprises a rectifier configured to rectify a voltage output from the resonant tank, and configured to supply the rectified voltage to a set of output nodes of the resonant DC-DC converter.

The switching network comprises a first switching arm and a second switching arm.

The first switching arm is configured to switchably apply the first external voltage supply selected from the first set of external voltage supplies to the first input node of the resonant tank, and the second switching arm is configured to switchably apply the second external voltage supply selected from the second set of external voltage supplies to the second input node of the resonant tank, thereby generating a multi-level switched voltage at the first and second input nodes of the resonant tank.

Accordingly, a resonant converter topology is provided which can generate a DC voltage to power a load from a plurality of different input DC sources.

Optionally, the resonant DC-DC converter is arranged so that the first and the second switching arms respectively comprise a first and a second plurality of switching elements. The switching network is configured to switch the switching elements of the first and the second pluralities of switching elements, so that, in any switching phase of the switching network, one switching element of each of the first and second pluralities of switching elements is in a low impedance condition, and the remainder of the switching elements of the first and second pluralities of switching elements is/are in a high impedance condition.

Accordingly, at any one time, one switching arm provides a DC voltage from one DC source out of a set of DC sources to a first/or a second node of the resonant converter.

Optionally, the switching network comprises a first switching element configured to connect a first supply node connected to the first set of external voltage supplies to the first input node of the resonant tank, and the switching network comprises a second switching element configured to connect a second supply node connected to the first set of external voltage supplies to the first input node of the resonant tank.

Optionally, the switching network comprises a third switching element configured to connect a third supply node connected to the second set of external voltage supplies to the second input node of the resonant tank, and the switching network comprises a fourth switching element configured to connect a fourth supply node connected to the second set of external voltage supplies to the second input node of the resonant tank.

Optionally, the first and the second input nodes of the resonant tank are configured to receive a multi-level input voltage having a plurality of voltage levels greater than two levels, and wherein one switching element is provided per different supply voltage to be applied at each input node of the resonant tank.

Accordingly, a resonant converter topology may be used to generate a DC voltage from multiple sets of DC voltage supplies.

Optionally, the first and second sets of external voltage supplies each comprise one voltage supply.

Optionally, the resonant tank comprises a DC-blocking capacitor connected in series with the first and/or second input nodes of the resonant tank.

Optionally, the resonant tank comprises a transformer.

Optionally, the switching elements are MOSFETS.

According to a second aspect, a DC electrical supply system is provided. The system comprises:

a resonant DC-DC converter according to the previous aspect, or its embodiments; and

a first set of external voltage supplies and second set of external voltage supplies connected to the resonant DC-DC converter configured to supply at least a first and a second external supply voltage to the resonant DC-DC converter.

The resonant DC-DC converter is configured to supply an output voltage to a load supply connection.

Optionally, at least one voltage supply of the set of external voltage supplies is provided as ground.

Optionally, at least two voltage supplies of the set of external voltage supplies input the same voltage value to the resonant DC-DC converter.

According to a third aspect, a method of operating a DC-DC resonant converter is provided, comprising:

a) receiving a first supply voltage selected from a first set of external voltage supplies at a first input node of a switching network;
b) receiving a second supply voltage selected from a second set of external voltage supplies at a second input node of the switching network;
c) alternately applying the first supply voltage and the second supply voltage to respective first and a second input nodes of a resonant tank, thereby generating a switched voltage at the first and second input nodes of the resonant tank;
d) rectifying the voltage output from the resonant tank; and
e) supplying the rectified voltage from the resonant tank as an output voltage.

Optionally, step c) further comprises:

c1) configuring switching elements of the switching network so as to provide one switching element of each of the first and second pluralities of switching elements in a low impedance condition, and to provide the remainder of the switching elements of the first and second pluralities of switching elements are in a high impedance condition.

In the following description, the term “resonant tank” means a network of components having a combination of inductive and capacitive reactance.

In the following description the term “switching network” means a plurality of electrical components which are switchable between a high impedance state and a low impedance state upon the application of a control signal. An example of such a component is a MOSFET (Metal Oxide Semiconductor Field Effect Transistor) or a power BJT (Bipolar Junction Transistor). These components are arranged in a MISO (Multiple In, Single Out) network, enabling the redirection of paths of DC voltage between input terminals and output terminals of the MISO network.

In the following description, the term “high impedance” refers to a characteristic of a switching element, such as a MOSFET, which is switched off (i.e., a control voltage prevents current flow between drain and source of the switching element, or a very high resistance over one, or tens of MΩ appears across the drain and source of the switching element).

In the following description, the term “low impedance” refers to a characteristic of a switching element, such as a MOSFET which is switched on (i.e., a control voltage enables current flow between drain and source of the switching element, or a very low resistance below hundreds or tens of mΩ appears across the drain and source of the switching element).

Therefore, it is a basic concept of the invention to provide a resonant DC-DC converter in which the switching network is configured to enable the resonant converter to be supplied from multiple sets of DC supplies.

### BRIEF DESCRIPTION OF THE DRAWINGS

Exemplary embodiments will be described with reference to the following drawings.

FIG. 1 shows the general concept of a resonant converter topology.

FIG. 2 shows a schematic of the switching network of a conventional resonant converter topology.

FIG. 3 shows a schematic of a conventional resonant converter topology.

FIG. 4 shows a block-diagram of a resonant DC-DC converter topology in accordance with the first aspect.

FIG. 5 shows a schematic view of the switching network of an embodiment of a resonant DC-DC converter according to the first aspect.

FIG. 6 shows a schematic view of an embodiment of a multi-level resonant DC-DC converter according to the first aspect.

FIG. 7. shows a schematic view of an embodiment of a DC electrical supply system according to the second aspect.

FIG. 8 shows a flow diagram of a method according to the third aspect.

FIG. 9 shows an example waveform of the operation of a resonant converter.

### DETAILED DESCRIPTION OF EMBODIMENTS

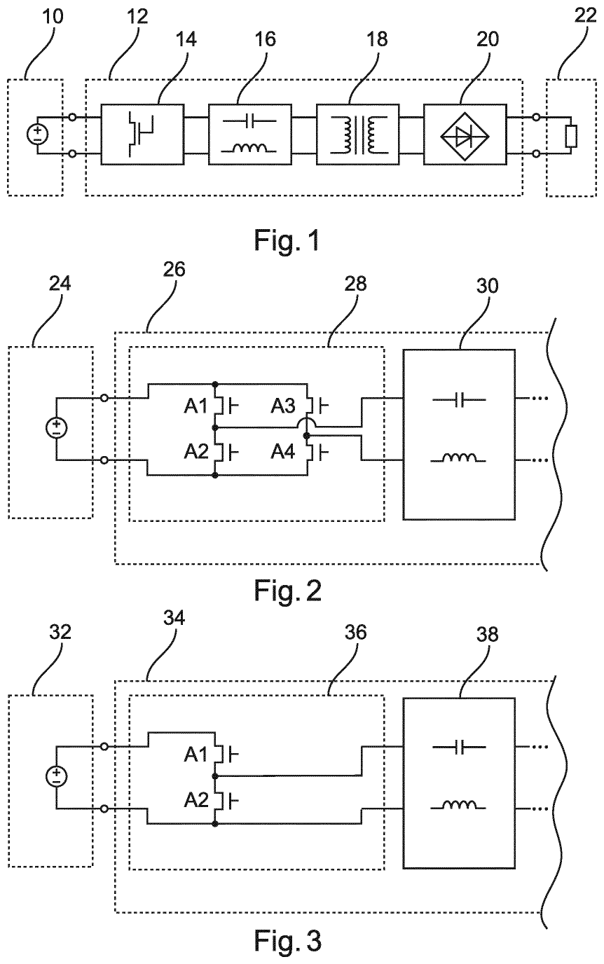

The resonant DC-DC converter topology is popular when DC-DC conversion must be provided in an efficient manner, for example in X-ray systems. Proceeding from the discussion of the general resonant DC-DC converter topology of FIG. 1, discussed in the background section, it will be appreciated that many overall variants of the DC-DC converter topology exist. Dependent on the converter variant, the implementation of each block may differ. However, regardless of the converter variant, the resonant DC-DC converters known in the art are supplied from one external power supply, and such resonant DC-DC converters supply one load.

FIG. 2 illustrates a variant of a conventional resonant DC-DC converter topology 26. The resonant DC-DC converter 26 is supplied from a single DC source 24. A switching network 28 is provided as a full-bridge converter constituted from switches A1, A2, A3, A4 connected in a full-bridge arrangement supplying a resonant tank 30. The switching network 28 is sometimes referred to as an “inverter”. A full-bridge is the preferred input stage in conventional resonant DC-DC converters including a transformer, as is typical in medical X-ray applications.

FIG. 3 illustrates a variant half-bridge resonant DC-DC converter 34 topology comprising a single DC voltage supply 32, a switching network 36, supplying a resonant tank 38. The switching network 36 comprises switching elements A1 and A2 only. A difference between resonant DC-DC converter 34 and resonant DC-DC converter 26 is that in resonant DC-DC converter 34, switching element A3 of DC-DC converter 26 has been replaced by an open circuit, and switching element A4 of DC-DC converter 26 has been replaced by a short circuit.

In the variant of FIG. 2, the two sets of switching elements (A1, A2 and A3, A4) full-bridge converters are supplied from the same power supply (constant voltage power source 24). They also supply the same load, a floating output, which is in this case a resonant tank 30, and the rest of the resonant converter 26. The switching network 28, and the load, are connected so that it is possible to apply either the supply voltage (V_{g}) or ground (GND) to each end of the load, which means that the resonant tank can be supplied by three different voltages (V_{g}, GND, and −V_{g}).

A problem of the approaches discussed above is that X-ray equipment continues to be miniaturized, and thus the power supply unit must also be shrunk. When designing integrated, or embedded systems, the design choice is often constrained by the form-factor of the equipment. In embedded systems, multiple supply systems are often available, and it could be advantageous to re-use available supply voltages.

Therefore, according to a first aspect, there is provided a resonant DC-DC converter 40.

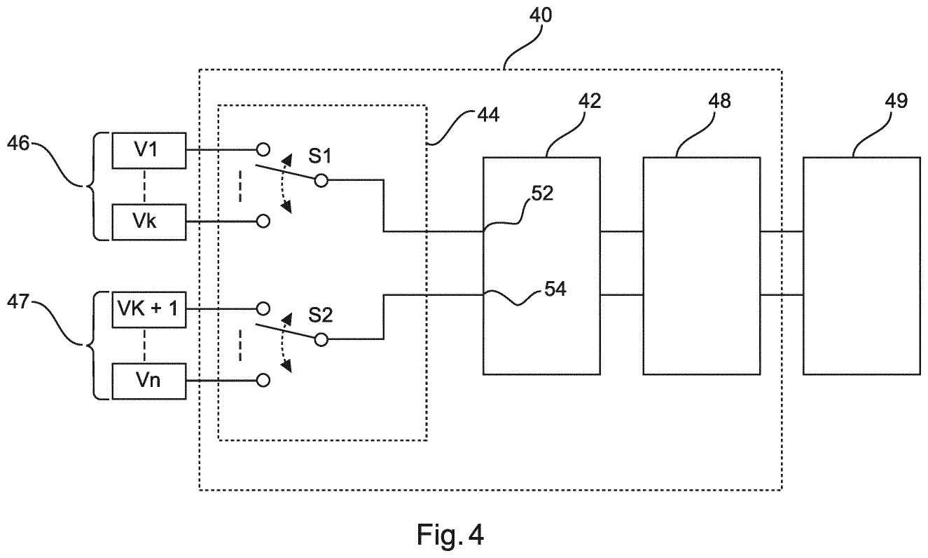

FIG. 4 illustrates a general embodiment of a topology for the resonant converter 40.

The resonant DC-DC converter 40 comprises:
a resonant tank 42 having first 52 and second 54 input nodes;
a switching network 44 configured to select a first external voltage supply from a first set 46 of external voltage supplies V₁, . . . , Vₖ, and configured to select a second external voltage supply from a second set 47 of external voltage supplies Vₖ₊₁, . . . , V_{N}, and to connect the selected first and second external voltage supplies to respective first 52 and second 54 input nodes of the resonant tank; and
a rectifier 48 configured to rectify a voltage output from the resonant tank, and configured to supply the rectified voltage to an output node of the resonant DC-DC converter.

The switching network 44, comprises a first switching arm S1 and a second switching arm S2.

The first switching arm S1 is configured to switchably apply the first external voltage supply from the first set 46 of external voltage supplies V₁, . . . , Vₖ to the first input node 52 of the resonant tank, and the second switching arm S2 is configured to switchably apply the second external voltage supply from the second set 47 of external voltage supplies Vₖ₊₁, . . . , V_{N} to the second input node 54 of the resonant tank, thereby generating a multi-level switched voltage at the first and second input nodes of the resonant tank.

The resonant converter 40 comprises ports allowing a first DC supply from a first set 46 of external supply voltages 46, V₁, . . . , Vₖ to be connected to a resonant tank 42 via first switching arm S1.

A second DC supply from a second set of external supply voltages 47, Vₖ₊₁ . . . V_{N} can be connected to the resonant tank via second switching arm S2.

Thus, first switching arm S1 of the switching network 44 enables the connection of one of the external supplies of the first set of voltage supplies 46, V₁, . . . , Vₖ to a first node 52 of the resonant tank.

Likewise, second switching arm S2 of the switching network 44 enables the connection of one of the external supplies of the second set of external voltage supplies 47, Vₖ₊₁ . . . V_{N} to a second node 54 of the resonant tank.

The resonant tank 42 has first 52 and second 54 input nodes. The first switching arm S1 connects the first node 52 to one of the external voltage supplies of the first set 46 of external supply voltages, V₁, . . . , Vₖ. The second switching arm S2 connects the second node 54 to one of the external voltage supplies in the second set of external supply voltages 47, Vₖ₊₁ . . . V_{N}.

Accordingly, a resonant converter topology is provided which can generate a DC voltage to power an external load 49 from a plurality of different sets of DC sources.

Optionally, the first switching arm S1 is configured to connect the external voltage supplies of the first set 46 of external voltage supplies V₁, . . . , Vₖ alternately, so that one external voltage supply from the first set 46 of external voltage supplies V₁, . . . , Vₖ is connected to the first node 52 of the resonant tank at any one time.

Optionally, the second switching arm S2 is configured to connect the external voltage supplies of the first set 47 of external voltage supplies Vₖ₊₁, . . . , V_{N} alternately, so that one external voltage supply from the second set 47 of external voltage supplies Vₖ₊ᵢ, . . . , V_{N} is connected to the second node 54 of the resonant tank at any one time.

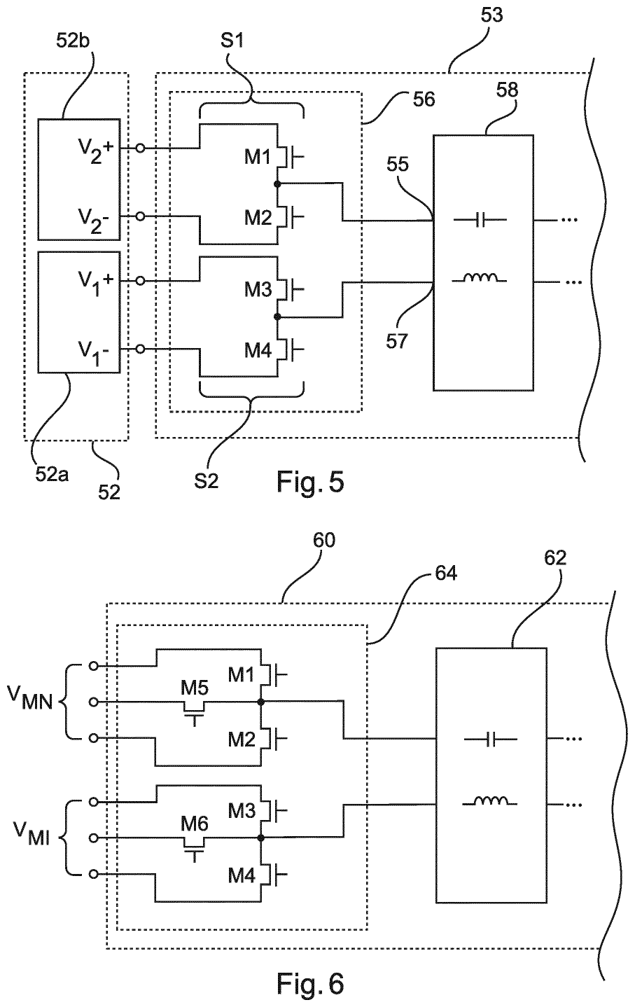

FIG. 5 schematically illustrates an exemplary implementation of a resonant DC-DC converter topology 54 according to an embodiment.

In this case, a resonant DC-DC converter 53 is configured to be connectable to a first DC-DC power supply 52a, and a second DC-DC power supply 52b. In this example, a first node 55 of the resonant tank 58 is connectable to the first DC-DC power supply 52a via the first switching arm S1 of the switching network 56. A second node 57 of the resonant tank 58 is connectable to the second DC-DC power supply 52b via the second switching arm S2 of the switching network 56. Although two DC-DC power supplies are illustrated (one in a first set, one in a second set), it will be appreciated that each node 55, 57 of the resonant converter may be supplied by one, or more DC-DC power supplies.

The switching network 56 comprises series-connected switching elements M1 and M2, and series-connected switching elements M3 and M4. Switching elements M1 and M2 form a first switching arm S1. Switching elements M3 and M4 form a second switching arm S2. When M1 is set in a low impedance state, and M2 is set in a high impedance state, a path between a first voltage connection of 52b and the resonant tank 58 is formed. When M1 is set in a high impedance state, and M2 is set in a low impedance state, a path between the second voltage connection of 52b and the resonant tank is formed.

When M3 is set in a low impedance state, and M4 can be set in a high impedance state, a path between the first voltage connection of 52a and the resonant tank 58 is formed. When M3 is set in a high impedance state, and M4 is set in a low impedance state, a path between the second voltage connection of 52a and the resonant tank is formed.

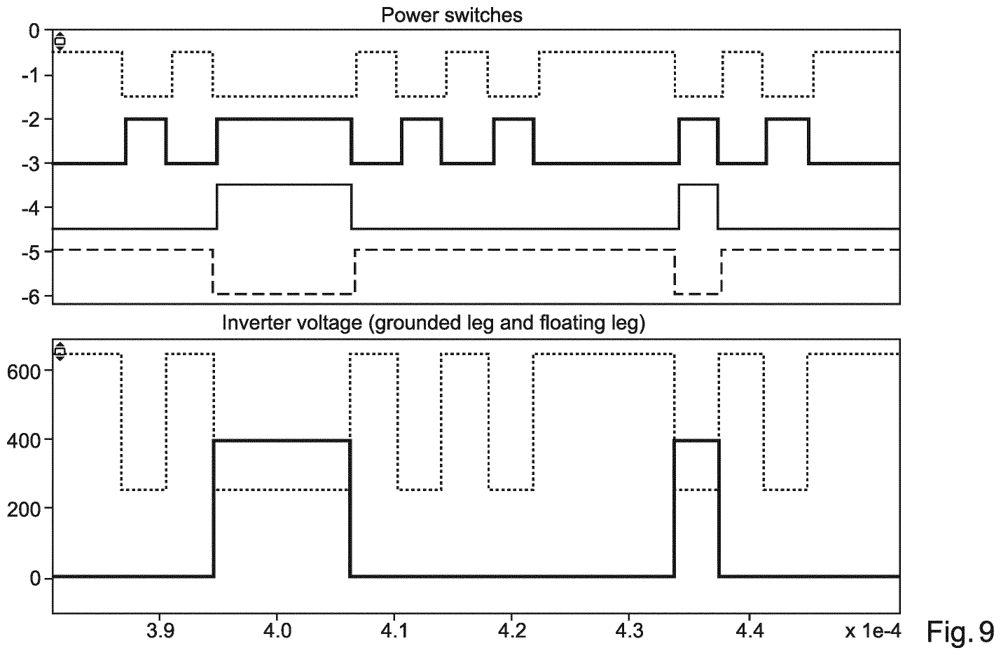

It will be appreciated that the switching elements M1-M4 are controlled by a variety of analogue switching means, or digital switching means (not shown). In the exemplary case that the switching elements M1-M4 comprise MOSFETS, the analogue or digital switching means are used to control the MOSFET gate connections. The switching elements can be controlled using a sequence which provides switched multi-level DC electrical energy to the resonant tank 58, as illustrated in the graph of FIG. 9. In this sense, in an embodiment, the term multi-level means that the switched DC electrical energy at the input nodes of the resonant tank may have a voltage of ground, and the supply voltage, but also intermediate switched DC voltage levels, as a result of the combination of voltage supply levels from voltage supplies of the first and second sets of external voltage supplies. #

Thus, according to an embodiment, the term “multi-level switched voltage” means a voltage which can take one, or a plurality, of intermediate voltage levels apart from the supply rail voltages of external voltage supplies.

An exemplary switching sequence for the example MOSFET switching network 56 shown in FIG. 5 is shown in Table 1:

TABLE 1

Phase

| Switch | 1 | 2 |
|---|---|---|
| M1 | 0 | 1 |
| M2 | 1 | 0 |
| M3 | 0 | 1 |
| M4 | 1 | 0 |

Exemplary switching phases of the switching network of FIG. 5

Table 1 describes a two-phase switching routine of the four switching elements M1-M4. A logical “1” indicates a low impedance of the relevant switching element, and a logical “0” indicates a high impedance of the relevant switching element.

A comparison of Table 1 with the schematic of FIG. 5 reveals that, as phases 1 to 2 are stepped between, the switching M1-M4 are actuated in such a way that the first 55 and second 57 input nodes of the resonant tank 58 are each connected to one supply voltage at a time. In other words, there is no case where the terminals of V1₊ and V1₃₁, and V2₊ and V2₋, are connected directly to each other.

This hardware configuration can be used with many different types of DC-DC power supply. However, in the example of FIG. 5, the DC-DC supplies 52a and 52b are identical.

This switching scheme may be generalized to different embodiments of the switching network. For example, a resonant DC-DC converter configured to be driven by four supplies, or a resonant DC-DC converter configured to be driven by three multi-level supplies would adhere to the same principle of not allowing supply rails of the same DC supply to be connected together via a switching element.

The switched application of the DC voltages from 52a and 52b enable the resonant tank to provide a large AC voltage, thus enabling the efficient powering of X-ray equipment, for example.

Optionally, the resonant DC-DC converter is arranged so that the first M1, M2 and the second M3, M4 switching arms respectively comprise a first and a second plurality of switching elements, and so that the switching network 44, 56, 64 is configured to switch the switching elements of the first and the second pluralities of switching elements, so that, in any switching phase of the switching network, one switching element of each of the first and second pluralities of switching elements is in a low impedance condition, and the remainder of the switching elements of the first and second pluralities of switching elements is/are in a high impedance condition.

Accordingly, at any one time, one switching arm provides a DC voltage from one DC source.

Optionally, the switching network 56 comprises a first switching element M1 configured to connect a first supply node connected to the first supply voltage to the first input node of the resonant tank 58, and the switching network 56 comprises a second switching element M2 configured to connect a second supply node connected to the first supply voltage to the first input node of the resonant tank 58.

Optionally, the switching network 58 comprises a third switching element M3 configured to connect a third supply node connected to the second supply voltage to the second input node of the resonant tank 56, and the switching network 56 comprises a fourth switching element configured to connect a fourth supply node connected to the second supply voltage to the second input node of the resonant tank 58.

The provision of different DC power supplies means that the supply voltages of the DC supplies may differ, causing the resonant tank 58 to be loaded with a DC voltage.

Optionally, the resonant tank comprises a DC-blocking capacitor connected in series with the first and/or second input nodes of the resonant tank. This functions to prevent the flow of the a DC current through nodes 55 to 57 of the resonant tank 58.

Optionally, the switching elements are MOSFETS. However, other power switching elements such as a Bipolar Junction Transistor (BJT), a TRIAC, a thyristor, an Insulated Gate Field Effect Transistor (IGFET), or the like, may be used.

Optionally, the resonant tank comprises a transformer.

More power supplies can be connected if more switching elements are used, as in the case of multi-level DC-DC converters.

FIG. 6 illustrates a multi-level resonant converter 60 having a first multi-level DC input V_{M1} and a second multi-level DC input V_{MN}. In this case, each of the multi-level DC inputs provides three different DC input voltages per input terminal. However, it will be appreciated that any number of sets of multi-level inputs may be provided, and each multi-level input may have any number of voltages per input terminal. In addition, according to an embodiment, a first set of multi-level inputs may have a different number of multi-level inputs, compared to a second set of multi-level inputs.

In this case, the resonant tank 62 is connected by the switching network 64 via switches M1, M2, M3, M4, M5, M6 to a certain voltage. Additional switches can be used to connect the ends to other voltages.

Optionally, the first and the second input nodes are configured to receive a multi-level input voltage having a plurality of voltage levels greater than two levels.

Accordingly, a resonant converter topology may be used to generate a DC-DC voltage from, multi-level DC voltage supplies.

According to a second aspect, a DC electrical supply system 70 is provided. The DC electrical supply system 70 comprises:

a resonant DC-DC converter 72 as described in the first aspect and its embodiments;

a first set of external voltage supplies 74a, and a second set of external voltage supplies 74b, 74c connected to the resonant DC-DC converter 72 to supply at least a first and a second external supply voltage to the resonant DC-DC converter, wherein the resonant DC-DC converter is configured to supply an output voltage to a load supply connection 76.

Optionally, at least one voltage supply of the first and/or second sets of external voltage supplies is provided as ground.

Optionally, at least two voltage supplies of the first and/or second sets of external voltage supplies input the same voltage value to the resonant DC-DC converter.

According to an embodiment of the second aspect, the set of external voltage supplies comprises a plurality of independent and grounded power supplies. Optionally, each supply of the plurality of independent and grounded power supplies may take a different DC value.

According to an embodiment of the second aspect, one input voltage rail is supplied from a regular grounded power supply, and the other one is supplied from a power supply with a voltage offset.

According to an embodiment of the second aspect, two input voltage rails are connected together at one terminal with a capacitor to ground, and the remaining two terminals are supplied by a grounded power supply.

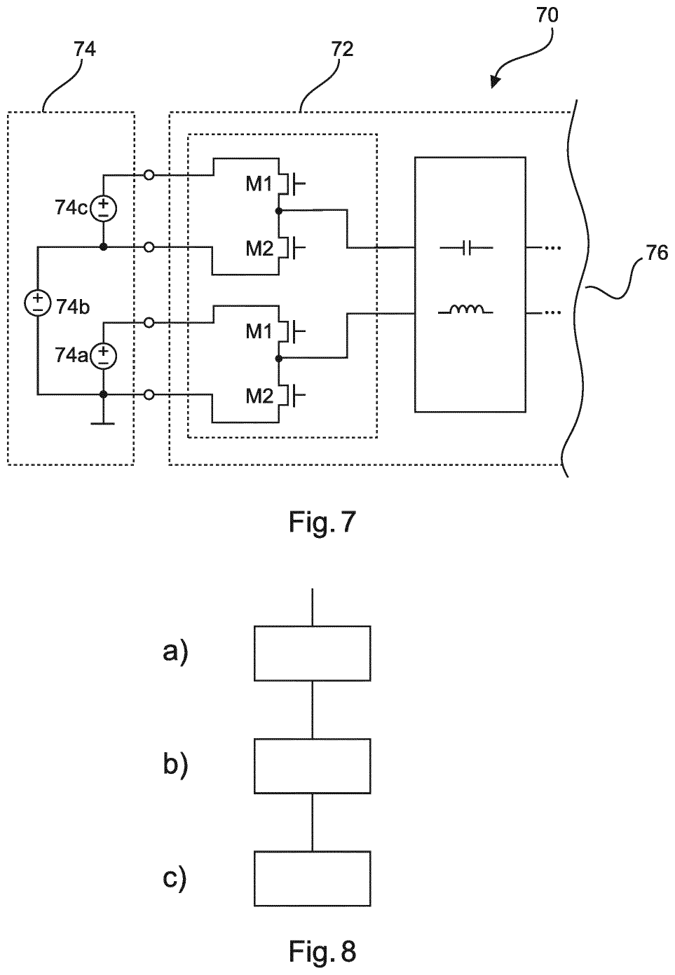

FIG. 7 illustrates a DC electrical supply system 70 having a resonant DC-DC converter 72 according to the first aspect. FIG. 7 illustrates an example of supplying the resonant DC-DC converter from a grounded DC power supply 74a, and a DC offset supply 74c superimposed on DC supply 74b.

According to an embodiment of the second aspect, the number of external power supplies in the first set of external supplies k=2, and the total number of supplies in the first and second sets of external supplies N=4. In this case, the first set of external supplies 46 provides V1 and V2. The second set of external supplies 47 provides V3 and V4. According to an example, voltages V2 and V4 are equal, and V1 and V3 are equal.

Of course, k may be any integer, and N maybe any integer greater than k. In addition, a third, fourth, and fifth set of external supplies may be provided.

According to a third aspect, a method of operating a DC-DC resonant converter is provided.

The method comprises:

a) receiving a first supply voltage selected from a first set of external voltage supplies V₁, . . . , Vₖ at a first input node of a switching network;
b) receiving a second supply voltage selected from a second set of external voltage supplies Vₖ₊₁, . . . , V_{N} at a second input node of the switching network;
c) alternately applying the first supply voltage and the second supply voltage to respective first and a second input nodes of a resonant tank, thereby generating a switched voltage at the first and second input nodes of the resonant tank;
d) rectifying the voltage output from the resonant tank; and
e) supplying the rectified voltage from the resonant tank as an output voltage.

FIG. 8 illustrates a method according to the third aspect.

According to an embodiment of the third aspect, the method further comprises:

c1) configuring switching elements of the switching network so as to provide one switching element of each of the first and second pluralities of switching elements in a low impedance condition, and to provide the remainder of the switching elements of the first and second pluralities of switching elements are in a high impedance condition. Accordingly, aspects and embodiments of the invention described above have discussed the provision of a more flexible resonant converter topology which may supply a high power DC load, based on DC power supplied from arbitrarily arranged sets (networks) of input DC-DC supplies. This is due to the topology which allows a multi-level switched DC voltage to be provided to the input nodes of a resonant tank in a DC-DC resonant converter.

FIG. 9 illustrates an example set of waveforms of the operation of a resonant converter, in an arrangement where the inverter has a grounded leg and a floating leg. In both graphs, the x-axes represent time. In both graphs, the y-axes represent the voltage at a particular node, at a particular time. The upper graph represents the switching signals applied to the gates of transistors M1-M4 of a circuit similar to that of FIG. 5. The four traces in the upper graph are shown to illustrate the timing phase relationship based on a normalised amplitude, and therefore the y-axis values of the four traces in the upper graph are not realistic values. The uppermost trace in the upper graph of FIG. 9 represents the gate switching signal M1, and the three lower traces represent the gate switching signals M2, M3, and M4, respectively. The lower graph represents the inverter voltage at the grounded and floating leg, resulting from the M1-M4 transistor phase relationship. In this case, the y-axis values represent simulated inverter voltages at the grounded and floating leg. A greater range of voltages across the grounded leg and floating leg of the inverter can be provided by the switching network for input to the resonant tank. Thus, FIG. 9 illustrates the multi-level switched DC concept which the topology enables for input to a resonant tank.

According to an embodiment of the third aspect, the first and second set of external voltage supplies comprise floating voltage supplies

It will be appreciated that above discussion concerns a high-voltage DC-DC generator which has application in the field of X-ray imagers. However, similar demands for miniaturisation at high power density are present in many applications, and the application is not restricted to high-voltage DC-DC generators for X-ray applications.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A resonant DC-DC converter, comprising:
a resonant tank having first and second input nodes;
a switching network configured to select a first external voltage supply from a first set of external voltage supplies having supply rail voltages relative to ground voltage, the switching network further configured to select a second external voltage supply from a second set of external voltage supplies having supply rail voltages relative to ground voltage, the switching network further configured to connect the selected first and second external voltage supplies to respective first and second input nodes of the resonant tank; and
a rectifier configured to rectify a voltage output from the resonant tank and supply the rectified voltage to a set of output nodes of the resonant DC-DC converter;
wherein the switching network comprises a first switching arm and a second switching arm;
wherein the first switching arm is configured to apply the first external voltage supply selected from the first set of external voltage supplies to the first input node, and the second switching arm is configured to apply the second external voltage supply selected from the second set of external voltage supplies to the second input node, such that a multi-level switched voltage is generated at the first and second input nodes;
wherein the first and the second switching arms respectively comprise a first and a second plurality of switching elements;
wherein the first and the second input nodes are configured to receive a multi-level input voltage having a plurality of voltage levels greater than two levels, wherein one switching element is provided per different supply voltage to be applied at each input node of the resonant tank; and
wherein the multi-level switched voltage can take one or a plurality of intermediate voltage levels in addition to the supply rail voltages of the external voltage supplies.

2. The resonant DC-DC converter of claim 1, wherein the switching network is configured to switch the switching elements of the first and the second pluralities of switching elements so that, in any switching phase of the switching network, one switching element of each of the first and second pluralities of switching elements is in a low impedance condition, and the remainder of the switching elements of the first and second pluralities of switching elements is in a high impedance condition.

3. The resonant DC-DC converter according to claim 1,
wherein a first switching element of the first plurality of switching elements is configured to connect a first supply node connected to the first set of external voltage supplies to the first input node of the resonant tank; and
wherein a second switching element of the first plurality of switching elements is configured to connect a second supply node connected to the first set of external voltage supplies to the first input node of the resonant tank.

4. The resonant DC-DC converter according to claim 3,
wherein a third switching element of the second plurality of switching elements is configured to connect a third supply node connected to the second set of external voltage supplies to the second input node of the resonant tank; and
wherein a fourth switching element of the second plurality of switching elements is configured to connect a fourth supply node connected to the second external voltage supply to the second input node of the resonant tank.

5. The resonant DC-DC converter according to claim 1, further comprising a DC-blocking capacitor connected in series with the first and/or second input nodes of the resonant tank.

6. The resonant DC-DC converter according to claim 1, wherein the resonant tank comprises a transformer.

7. The resonant DC-DC converter according to claim 1, wherein the first and second plurality of switching elements are MOSFETS.

8. A DC electrical supply system, comprising:
a first set of external voltage supplies and a second set of external voltage supplies; and
a resonant DC-DC converter that includes:
a resonant tank having first and second input nodes;
a switching network configured to select a first external voltage supply from the first set of external voltage supplies having supply rail voltages relative to ground voltage, the switching network further configured to select a second external voltage supply from the second set of external voltage supplies having supply rail voltages relative to ground voltage, the switching network further configured to connect the selected first and second external voltage supplies to respective first and second input nodes of the resonant tank; and
a rectifier configured to rectify a voltage output from the resonant tank and supply the rectified voltage to a set of output nodes of the resonant DC-DC converter;
wherein the switching network comprises a first switching arm and a second switching arm;
wherein the first switching arm is configured to apply the first external voltage supply selected from the first set of external voltage supplies to the first input node, and the second switching arm is configured to apply the second external voltage supply selected from the second set of external voltage supplies to the second input node such that a multi-level switched voltage is generated at the first and second input nodes;
wherein the first and the second switching arms respectively comprise a first and a second plurality of switching elements;
wherein the first and the second input nodes are configured to receive a multi-level input voltage having a plurality of voltage levels greater than two levels, wherein one switching element is provided per different supply voltage to be applied at each input node of the resonant tank; and
wherein the multi-level switched voltage can take one or a plurality of intermediate voltage levels in addition to the supply rail voltages of the external voltage supplies;
wherein the resonant DC-DC converter is configured to supply an output voltage to a load supply connection.

9. The DC electrical supply system of claim 8, wherein at least one voltage supply of the first set or the second set of external voltage supplies is provided as ground.

10. The DC electrical supply system of claim 8, wherein at least two voltage supplies of the first set or the second set of external voltage supplies input the same voltage value to the resonant DC-DC converter.

11. The DC electrical supply system of claim 8, wherein the first and second set of external voltage supplies comprise floating voltage supplies.

12. A method of operating a DC-DC resonant converter, comprising:
receiving a first supply voltage selected from a first set of external voltage supplies at a first input node of a switching network, the first set of external voltage supplies having supply rail voltages relative to ground voltage;
receiving a second supply voltage selected from a second set of external voltage supplies at a second input node of the switching network, the second set of external voltage supplies having supply rail voltages relative to ground voltage;
alternately applying the first supply voltage and the second supply voltage to respective first and a second input nodes of a resonant tank, such that a switched voltage is generated at the first and second input nodes of the resonant tank, wherein the first and the second switching arms respectively comprise a first and a second plurality of switching elements, wherein the first and the second input nodes of the resonant tank are configured to receive a multi-level input voltage having a plurality of voltage levels greater than two levels, wherein one switching element is provided per different supply voltage to be applied at each input node of the resonant tank, and wherein the multi-level switched voltage can take one or a plurality of intermediate voltage levels in addition to the supply rail voltages of the external voltage supplies;
rectifying the voltage output from the resonant tank; and
supplying the rectified voltage from the resonant tank as an output voltage.

13. The method of claim 12, further comprising:
configuring the switching elements to provide one switching element of each of the first and second pluralities of switching elements in a low impedance condition, and to provide the remainder of the switching elements of the first and second pluralities of switching elements in a high impedance condition.
